(19) United States
(12) Patent Application Publication
(10) Pub. No.: US 2006/0011033 A1
(43) Pub. Date: Jan. 19, 2006

(54) Mitre saw with adjustable fence

(76) Inventors: Mirco Rossetti, Perugia (IT); Marcello Bettacchini, Perugia (IT)

Correspondence Address: Adan Ayala;Black & Decker Corporation, 701 East Joppa Road TW 199, Towson, MD, 21286, US

(21) Appl. No.: 10/517,099

(22) PCT Filed: Jun. 4, 2003
(86) PCT No.: PCT/EP03/05849

§ 371 Date: Jul. 5, 2005

(30) Foreign Application Priority Data
Jun. 8, 2002 (GB) 0213194.4

(51) Int. Cl. B23D 19/00

(52) U.S. Cl. 83/471.3; 83/477.1; 83/581

(57) ABSTRACT

A miter saw 110 having an operable cutting blade 122 pivotally supported relative to a working surface 114 and displaceable in a first cutting plane which intersects the work surface 114 along a first cutting line X-X. The miter saw has an adjustable elongated fence 134 angularly displaceable relative to the first cutting line X-X. The fence 134 is adjustably mounted on and supported by the working surface 114.

### FIELD OF THE INVENTION

The present invention is directed to miter saws and more particularly to power driven miter saws where the angle between the cutting blade and the support fence is adjustable to provide for a wide range of cutting angles.

### BACKGROUND OF THE INVENTION

Power driven miter saws of this type are well known and commonly used on building sites and by those involved in woodworking to allow for ease of cutting various lengths of wood to have required simple or complex (compound) cut angles. The basic type of miter saw simply comprises a circular saw blade which is operable in a cutting plane substantially perpendicular to a work surface on which the workpiece to be cut is supported by an appropriate fence. The plane in which the blade is operable can then be angularly adjusted relative to the fence (which is fixed relative to the base of the miter saw) to change the cutting angle relative thereto.

Alternatively, such miter saws may additionally further provide for the blade to be adjustably inclined relative to the work surface to provide for bevel cuts (or compound miter cuts) whereby the blade is not only inclined in a first plane relative to the work surface (and thus the workpiece) but also has a second angular component relative to the fence. Such compound miter cuts are commonly used for producing roofing joints. One further design variant of miter saws allow the blade not only to be raised and lowered relative to the work surface but also, in the use of cross cut miter saws, to be displaced longitudinally outwardly of such a work surface to produce a sliding compound miter saw. However, in all such variants, the basic operation of the miter saw remains constant, that is: the circular saw blade employed is operative in a first cutting plane relative to the work surface where this plane intersects the work surface at a first cutting line and this cutting line can be angularly inclined relative to a fixed fence on the miter saw to define the appropriate miter angle required.

Typical prior art miter saws comprise a fixed base assembly having a rotatable table or work surface, on which the adjustable saw blade securely mounted for corresponding rotation relative to the base and is also pivotally mounted so that a user can downwardly pivot the saw assembly to bring the blade towards this table, as shown in FIG. 1. The base assembly has fixedly mounted thereon the miter fence, so that the table not only rotates relative to the base assembly but also relative to the fence. In this manner, since the cutting plane defined by the adjustable blade intersects the rotatable table assembly in a first cutting line, the cutting line of such blade can then be angularly inclined relative to the fence to select the miter angle. Once a miter angle has been selected the table is then releasably secured to the base unit to lock the saw the appropriate angle.

One example of a miter saw of this type is disclosed in the Applicants' corresponding European Patent Application EP 0 949 048 showing a portable miter saw of this type, although the same principle of operation is equably applicable on prior art stationary miter saws employing larger work surfaces or bases.

Another example is shown in FIG. 1. FIG. 1 shows a conventional miter saw according to the prior art. This miter saw 10 has a fixed base assembly 12 having rotatably mounted thereon a table 14. Securely fixed to the rotatable table 14 is a saw assembly 16 which basically comprises a handle 18 (usually comprising a trigger switch, not shown) together with a motor housing 20 housing an electric motor (either mains operated or battery operated) with a conventional bearing assembly and output for driving a circular saw blade 22, which is shown here housed behind an automatically adjustable blade guard 24. The entire saw assembly 16 is mounted on a conventional hinge arrangement 26 so as to pivot about an axis A, so as to pivotally displace the blade 22 towards the work surface 14 in a first cutting plane.

As is conventional for miter saws of this type (and, as such, will not be described in great detail herein), the adjustable blade guards 24 are automatically displaced about the circumference of the blade housing 25 as the saw assembly 16 is pivotally displaced towards the table 14, so as to expose the rotating blade 22 as it approaches this work surface and a workpiece mounted thereon.

The blade 22 defines a first cutting plane through which pivotal displacement of the saw assembly 16 moves the blade 22. The plane in which this blade 22 itself lies, perpendicular to axis A, is defined as the cutting plane and is represented by the plane through which the blade 22 itself is pivotally displaceable. This cutting plane subsequently intersects the table 14 along a cutting line illustrated by the line X-X in FIG. 1 and along which cutting line X-X the table 14 is provided with an elongated groove or channel 30 which will accommodate the blade 22 as it is pivotally displaced into cutting engagement with a workpiece placed on table 14.

The miter saw 10 further includes a fence assembly 32 which comprises two separate sections 34a, 34b each rigidly secured to the base member 12, and restrained from rotation thereto. This fence assembly 32 presents a workpiece supporting portion against which a workpiece (such as a length of timber) may be disposed and held firm during the cutting operation.

This fence assembly 32 further comprises a gap or recess 36 overlying the cutting line X-X so as not to inhibit or engage the rotating blade 22 during the cutting operation. As illustrated in FIG. 1, the adjacent end faces 38a, 38b of the fence assembly 32 disposed either side of this recess 36 may be either vertical 38a (where the saw blade 22 is to be maintained in a cutting plane which is not angularly adjustable relative to the work surface) or alternatively, if the miter saw is a compound miter saw, whereby the hinged connection of the saw assembly 16 is rotatable (so as to incline the axis A and thus the angle of inclination of the cutting plane relative to the work surface (as will be described below)) then the end face 38b of the fence 34a is inclined so as to facilitate operation of and accommodate the blade when in such an inclined cutting plane relative to the table 14.

The miter saw 10 of FIG. 1 illustrates a miter saw orientated for cutting at right angles. Here the cutting line X-X is disposed substantially at an angle α of 90° relative to the fence assembly 32 so as to provide a right angled cut through a workpiece placed on this saw 10 adjacent to the fence 32 as the blade 22 is pivotally lowered into engagement therewith.

In order to vary the miter angle of cut of such saw, the table 14 is rotated relative to the base assembly 12 by releasing a fixing mechanism 40 between the table 14 and the base assembly 12. In the prior art example of FIG. 1, a rotatable screw threaded engagement member 40 provides a releasable locking mechanism between two work surfaces and the base assembly 12. As is conventional in the art, rotation of this table 14 in the direction shown generally by arrows B in FIG. 1 effects angular displacement of cutting line X-X relative to the base assembly 12 and hence fixed fence 32, thereby varying the angle α therebetween and hence the miter cutting angle.

The table 14 is provided with an indicia marking 44 which is read against a fixed angular scale (or indicia) 46 on the base assembly 12 to determine the exact angle α between the cutting line X-X and the fence 32. In this manner, the operator can pre-select the required miter angle by adjustment of the table 14 until the correct angular alignment is achieved, and the table 14 is then secured in engagement with the base station 12 at this pre-determined angle.

However, while this type of conventional miter saw provides for an efficient manner of adjusting the miter angle, the mechanisms employed to provide for such a rotatable table releasably secured to a base assembly are somewhat complex and expensive to manufacture and service.

### SUMMARY OF THE INVENTION

According to the present invention, a miter saw may have an operable cutting blade supported relative to a work surface and displaceable in a first cutting plane wherein this cutting plane intersects the work surface along a first cutting line, the miter saw may further comprise an adjustable elongate fence angularly displaceable relative to this first cutting line, the fence being preferably mounted on and supported by the work surface so as to be angularly displaceable thereon relative to said cutting line. Such miter saws may further comprise means for inclining the cutting plane relative to the work surface, as is conventional in miter saws used for producing bevel cuts, whereby this cutting plane still intersects the work surface along said cutting line.

Preferably, the work surface will comprise a recessed channel along the first cutting line for accommodating the blade when the blade is displaced in this first cutting plane so as to pass through the cutting line. Preferably, the fence will comprise at least one releasable restraint member for restraining the fence to the work surface in a plurality of angularly adjusted orientations relative to the cutting line so that the user may selectively adjust the miter angle required and lock the fence in the appropriate position.

In addition, the present invention may also provide for a miter saw which allows the fence to be longitudinally adjusted along the cutting line so as to vary the operative cutting depth provided by such miter saws. This feature is particularly beneficial for use with compound sliding miter saws for cutting objects having varied thicknesses and depth.

Preferably, the fence itself will extend over the cutting line so as to support a workpiece either side of the cutting line during the cutting operation. Here, the fence will usually have a recess form therein for overlying the cutting line and, in particular, the recessed channel in the work surface, so as not to inhibit or engage the blade as it performs the cutting operation and passes through the work surface. As such, it is preferable that the fence comprise at least two separate elongate sections, each presenting a support face extending perpendicular to the work surface in the same fence plane, with the recess here formed as a break between these two separate sections. At least one of the adjacent free ends of the separate sections of the fence may be inclined longitudinally outwardly of this break so as to provide an inclined support surface to the object to be cut which accommodates the blade when the cutting plane is inclined relative to the work surface.

Where the fence comprises separated sections disposed either side of the cutting line, the separate sections are preferably interconnected by a rigid support element extending therebetween so as to be remote from the recess. Usually this rigid support element will be substantially U-shaped extending out of the fence plane so as not to interfere with the blade in the cutting operation. Alternatively, this support element may extend substantially in the fence plane so as to be disposed below the work surface, again to avoid interference with the blade during the cutting operation. Alternatively, the separate sections of the fence may not be interconnected but may both be restrained in the same fence plane independently of one another, maintaining a constant angle of inclination of the fence relative to the cutting line.

It is preferable that the fence is pivotally mounted on the work surface about at least one pivot axis, wherein such a pivot axis is usually disposed substantially adjacent to the cutting line.

Preferably, the work surface will comprise at least one guide track and the fence will comprise at least one track following member in co-operative sliding engagement therewith, which facilitates the angular adjustment of the fence about the cutting line. In one embodiment, the track itself may be linear whereby it is therefore preferable that the or the at least one track following member is longitudinally adjustable along the elongate fence as the fence is pivoted about the pivot axis. Alternatively, or in combination, the work surface may in fact comprise at least two tracks and the fence comprise at least two track following members for co-operating engagement therewith. Again one or both of the track following members may be longitudinally adjustable about this elongate fence and the fence may optionally utilise a fixed pivot axis or may be simply inclined between the two tracks themselves relative to the cutting line.

Alternatively, some or all of the tracks may be arcuate, preferably disposed to be coaxial with the pivot axis where used. In this situation, the track following members may be securely fixed to the fence so as to follow the arcuate paths coaxial with the pivot axis. Alternatively, the fence may be pivotally mounted about at least one of the track following members and so to be both slideably adjustable relative to the cutting line in a longitudinal direction and also angularly displaceable thereabouts.

It is preferable that at least one of the track follower members would form at least one of the releasable restraint members for restraining the fence to the work surface. Such releasable restraint members may be rotatably adjustable to effect such engagement with the work surface. The screw threaded engagement may be achieved with a washer or nut member disposed within the track so as to exert a compressive force on the work surface disposed between such washer and the fence.

???In an alternative embodiment of the present invention, such miter saws may employ work surfaces comprising an array of first engagement means for co-operative releasable engagement with at least one second engagement means on the fence for restraining the fence on the work surface at a pre-determined angular inclination relative to the cutting line, wherein engagement of the second engagement means with a different one of the array of first engagement means restrains the fence in a second pre-determined angle relative to the cutting line. Usually the first engagement means will comprise an array of holes in the work surface and the second engagement means will comprise at least one projection member for engagement with one of the array of holes to effect appropriate angular alignment relative to the cutting line. Such projection members may comprise elongate members for co-operating engagement in corresponding angularly inclined (relative to cutting line) elongate slots, or may further comprise a plurality of projections for engagement with a plurality of holes to define the angular orientation, wherein the holes are appropriately positioned on the work surface so that engagement therewith would facilitate an appropriate angular inclination relative to the cutting line. It is usual that the projection members may be longitudinally adjustable along the fence.

### BRIEF DESCRIPTION OF THE DRAWINGS

A preferred embodiment of the present invention will now be described, by way of example only, with reference to the accompanying illustrative drawings in which:

FIG. 1 shows a miter saw according to the prior art; and

FIG. 2 shows a miter saw according to the present invention; and

FIG. 3 is a plan view from above of the miter saw of FIG. 2, illustrating an adjustable fence; and

FIG. 3a is a cross sectional view of the fence of the miter saw of FIG. 3 along the lines III-III illustrating a fence restraint member; and

FIG. 4 illustrates a second embodiment of an adjustable fence according to the present invention; and

FIG. 5 is a schematic illustration showing relative angular inclination of the cutting plane relative to the work surface of the miter saw of FIG. 2.

### DETAILED DESCRIPTION

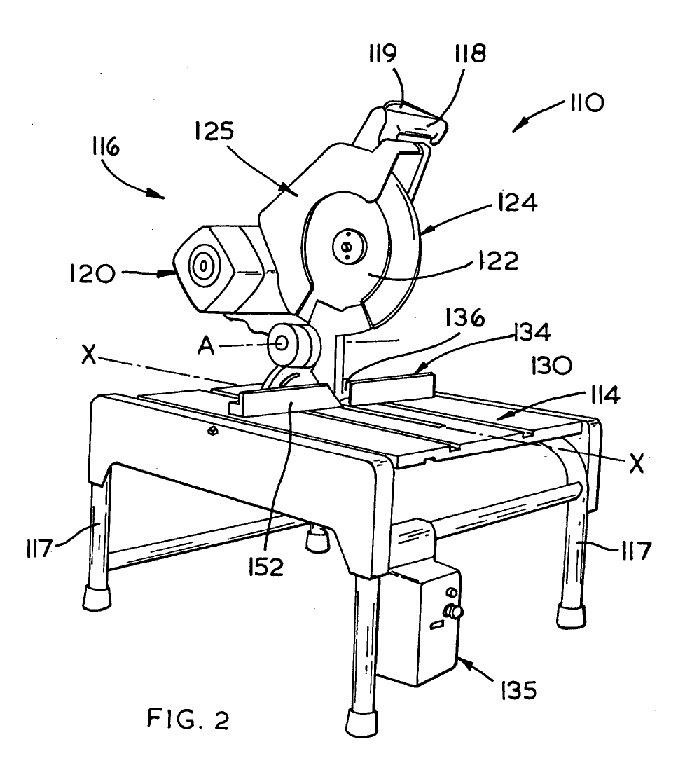

Referring now to FIG. 2, showing the present invention, the table miter saw 110 preferably has a saw assembly 116 comprising a motor housing 112 which is connected through a bearing assembly (not shown) to a circular saw blade 122. The saw assembly 116 may have a handle 118 with a trigger switch 119. Handle 118 may be mounted to motor housing 112. Blade 122 may be mounted within a blade housing 125 and surrounded by a displaceable blade guard 124.

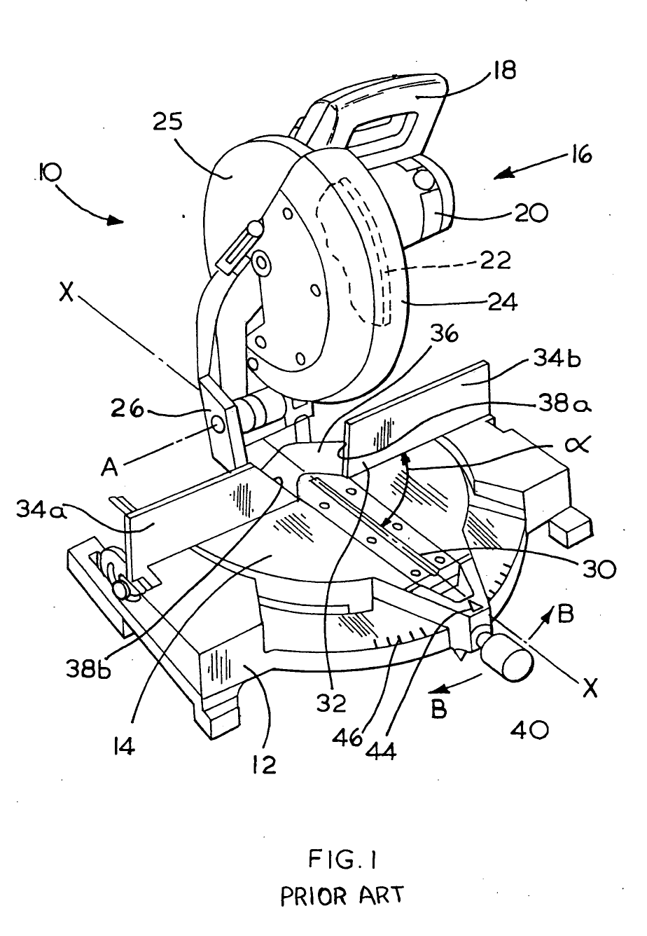

Saw assembly 116 may be mounted on a table or working surface 114. Work surface 114 may be securely mounted on four sturdy legs 117 to provide a stationary miter saw. Persons skilled in the art will recognize that, while the work surface 114 is shown as mounted on legs 117, the current invention is equally applicable to a portable miter saw of the type shown in FIG. 1. Saw assembly 116 is preferably pivotally mounted about an axis A through a conventional hinge arrangement so as to allow pivotal displacement of the saw blade 122 towards the work surface 114 about this axis A, as described with reference to FIG. 1.

The work surface 114 may have an elongate recess or groove 130 for accommodating the blade 122 as it passes through the upper surface of this work surface 114. As in the prior art embodiment of FIG. 1, the circular saw blade 122 may also be operative and rotatable in a first cutting plane which intersects with the work surface 114 along a cutting line shown again as X-X in FIG. 2.

The saw assembly 116 may be operated and controlled via a power box 135 receiving power input from a mains source.

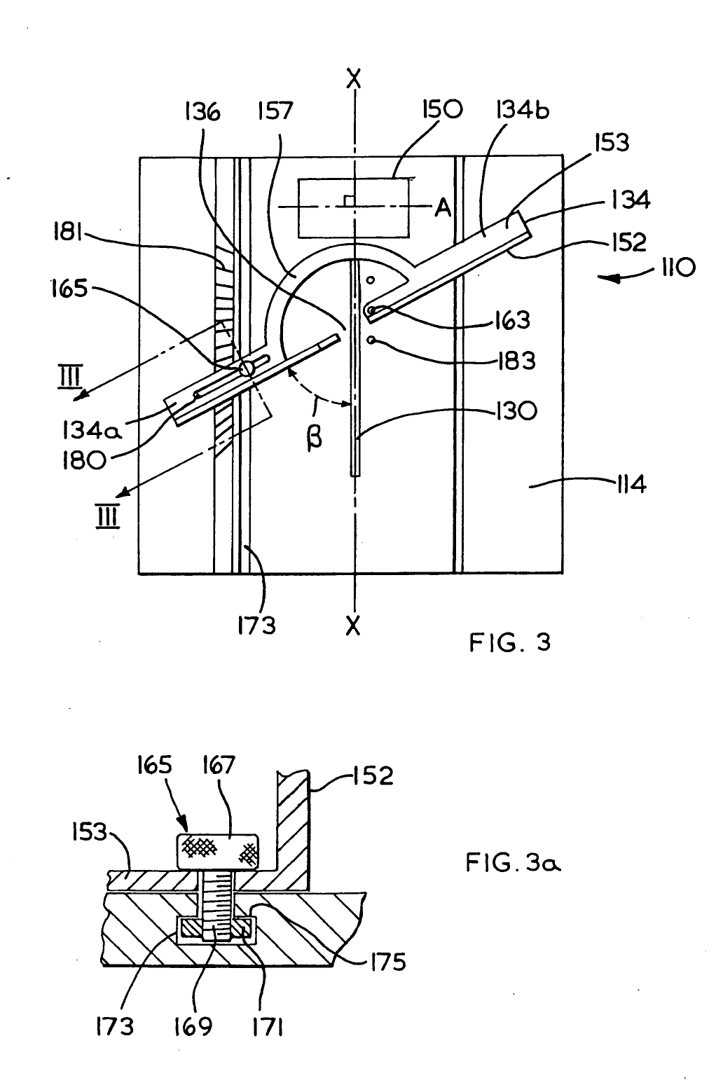

The saw 110 may further comprises an adjustable fence member 134. Fence member 134 may be pivotally adjustable over the surface of the work surface 114 so as to vary the angle between this fence member 134 and the cutting line X-X as will be more readily understood with reference to FIG. 3.

FIG. 3 shows a schematic plan view from above of the miter saw 110 of FIG. 2 with the saw assembly 116 removed. The engagement between the saw assembly 116 and the work surface 114 is shown schematically at 150, showing the pivot axis A disposed at right angles to the cutting line X-X.

As can be seen from FIGS. 2 and 3, the saw assembly 116 and work surface 114 are preferably secured relative to one another and are fixed relative to a base and/or legs 117, so as to be non rotatably mounted thereon. Fence member 134 may be mounted on the work surface 114 to be angularly adjustable relative thereto, and adjustable relative to the cutting line X-X.

Since the pivot axis A (about which the blade 122 is able to pivot) is now fixed relative to the work surface 114, the cutting plane may also be fixed relative to the work surface 114 and is considered to be represented by a plane extending out of the paper, so as to be perpendicular thereto, along the line X-X of FIG. 3.

Fence member 134 may be substantially L-shaped in cross section (FIG. 3a and FIG. 2). Fence member 134 may comprise an upright workpiece engaging face 152, lying in a fence plane extending substantially perpendicular to the work surface 114, and a rear stabilising flange 153 which preferably lies against the work surface 114. Fence member 134 may be divided into two separate sections 134a, 134b, forming a channel or recess 136 therebetween, similar to the recess formed in the fence 32 of FIG. 1. As will be appreciated from the Figures, this recess 136 preferably overlies the recessed channel 130 of the work surface 114 (and hence the cutting line X-X) and so allows for the blade 122 to pass between the fence member 134 without engagement therewith.

In this embodiment of the current invention, the two distinct sections 134a, 134b of the fence member 134 are preferably interconnected by a substantially U-shaped rigid support element 157 (FIG. 3), which may be disposed rearwardly of the engaging face 152 and remote from the aperture 136 so as not to interfere with the blade 122 during operation of the miter saw 110.

Alternatively, this U-shaped support section 157 could be formed so as to pass through the working surface 114 and underlie both the working surface 114 and the channel 130 again so as to not interfere with the blade 122 in operation. In such an alternative embodiment, the faces 152 of the fence member 134 define a substantially perpendicular plane to the working surface 114, i.e., the fence plane, whereby the support member 157 would then preferably lie substantially in this fence plane. The main function of the support member 157 is to restrain the two separate sections 134a, 134b from relative angular or longitudinal displacement to one another so that their faces 152 are maintained substantially co-planar in this fence plane.

The fence member 134 (and fence plane) may be angularly displaceable relative to the cutting line X-X (angle β). This angular adjustment is achievable by a variety of methods and techniques all of which are considered to fall within the scope of the current invention. In the embodiment shown in FIG. 3, the fence member 134 to be pivotally attached via a pivot member 163 having a pivot axis extending perpendicular to the working surface 114, which is preferably disposed on the inner end of fence member 134b. Fence member 134 is preferably rotatably displaceable about such pivot member.

The pivot member may comprise a pin member extending through the fence member 134 into a corresponding aperture within the working surface 114. The second fence section 134a may be further provided with a restraint member 165 which passes through this fence section for co-operative engagement with the working surface 114 to releasably engage therewith to secure the fence member 134 in its desired angular orientation.

This restraint member 165 (shown more clearly in FIG. 3a) may comprise a rotatable knurled knob 167 having an elongate screw threaded section 169 for co-operative screw threaded engagement with a nut member 171 slideably received within a longitudinally extending undercut slot 173 formed within the working surface 114. The nut member 171 is preferably slidably displaceable within this undercut slot 173 but restrained from rotational displacement therein (e.g., such as by use of a hexagonal or square nut which engages the side walls of such slot 173).

When the restraint member 165 is rotated clockwise so as to effect screw threaded arrangement between the threaded section 169 and the nut 171, the nut 171 is forced upwardly along the length of the threaded section 169. Nut 171 thereby engages with the shoulders 175 of the undercut slot 173, resulting in a compressive force being applied between the nut 171 and the knob 167, in turn compressing the fence member 134 into engagement with the working surface 114 to frictionally restrain the fence member 134 in engagement therewith.

When the knob 167 is rotated in a counter-clockwise direction, such compressive force is relieved, allowing the restraint member 165 to be slideably displaceable along the slot 173 as the fence member 134 is pivoted about pivot point 163 to change the angular displacement β between the fence member 134 and the cutting line X-X.

The fence section 138 may also comprise an elongated aperture 180 for accommodating the restraint member 165. Such aperture 180 may allow the restraint member 165 to be longitudinally displaceable along the fence member 134a to compensate for the longitudinal displacement of the fence member 134a relative to the channel 173 during the pivotal displacement about pivot point 163.

Working surface 114 may be further provided with indicia markings 181 defining appropriate angular configurations β to allow the user to correctly set angle β as required by aligning the fence member 34 with such markings.

The current invention further provides for longitudinal adjustment of the fence member 134 longitudinally along the cutting line X-X. Since the fence member 134 may be simply pivotally engaged with the working surface 114 by use of a pin member through the pivot point 163, the entire fence member 134 can be displaced along the line X-X and again pivotally operated in the manner previously described by longitudinal adjustment of this pivot axis, in a direction parallel to the cutting line X-X and subsequent engagement with an alternatively longitudinally displaced hole 183. This longitudinal adjustment of the fence provides an additional advantage of allowing different sized workpieces to be cut. Additionally, the indicia 181 may be reset so as to be correctly aligned with the alternative pivot axis position 183 to again ensure the user is able to correctly determine angle β by use of such indicia being aligned with the fence plane. The longitudinal adjustment of the fence may be particularly beneficial when used in conjunction with a sliding compound miter saw.

Persons skilled in the art should recognize that, while the pivot point 163 is shown substantially adjacent to the cutting line X-X, this pivot axis could be alternatively displaced anywhere along the length of the fence section 134b provided that the aperture 136 is sufficiently large to prevent either of the fence sections 134a, 134b overlying the cutting line X-X in any one of the desired angular settings β.

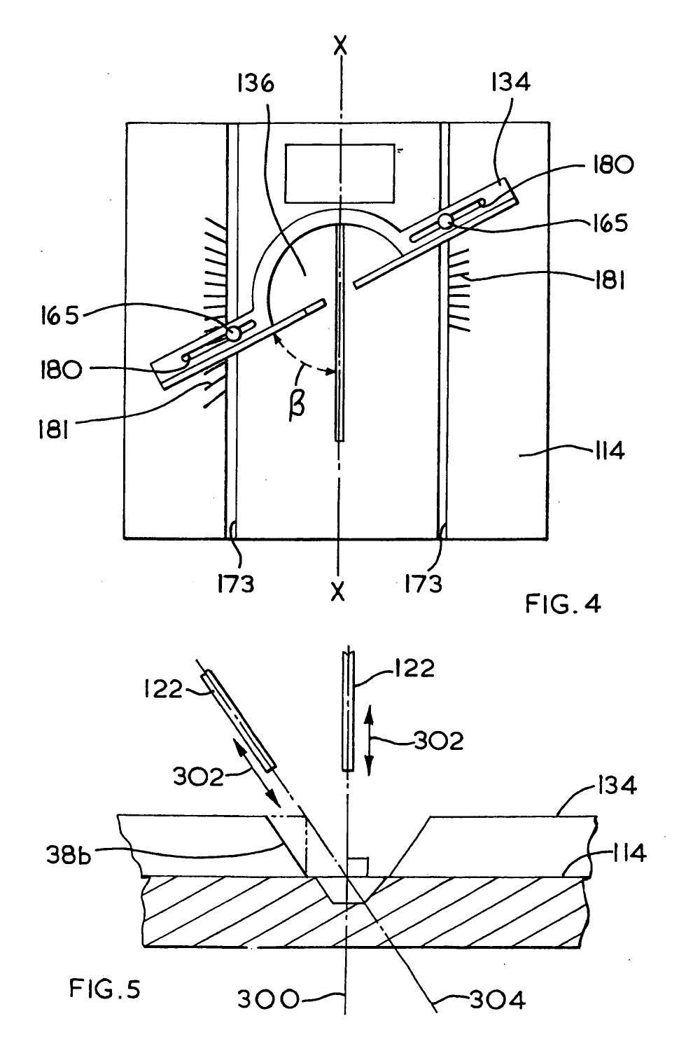

FIG. 4 shows an alternative arrangement of an adjustable fence mechanism for use with the miter saw 110 of FIG. 2. In this embodiment, the pivot axis 163 of the embodiment shown in FIG. 3 is removed and both sections 134a, 134b of the fence member 134 are provided with restraint members 165 with corresponding, longitudinally extending apertures 180 (as previously described with reference to FIG. 3)). Both restraint members 165 co-operate with corresponding longitudinally extending slots 173 formed in the working surface 114 in the manner previously described with reference to FIG. 3.

In this situation, the fence member 134 may be slideably adjustable along both slots 173 by releasing the restraint members 165, allowing the fence plane to be aligned between two sets of indicia 181 designating the appropriate miter angle (one each associated with each slot 173), with the operator ensuring that the recess 136 overlies the cutting line X-X. Again for this embodiment, the fence 134 may be longitudinally displaceable along the cutting line X-X by appropriate displacement along the channels 173, whereby the indicia associated with each channel 173 may also be displaceable and reset in this longitudinal direction to allow correct determination of the angle β. Once the appropriate angle β has been determined by alignment of the fence member 134 with the appropriate indicia, both of the restraint members 165 may then be engaged to restrain the fence member 134 in that desired position.

The current invention is also applicable to compound miter saws whereby the cutting plane in which the blade 122 is operable, is angularly adjustable relative to the working surface 114. This is clearly shown in FIG. 5 showing a schematic cross section through the miter saw 110 of FIG. 2, schematically illustrating the cutting plane 300 when the blade 122 is in the position shown in FIG. 2 and disposed substantially at right angles to the working surface 114, wherein the blade 122 is vertically displaceable into and out of engagement with a workpiece mounted on the working surface 114 (shown generally by arrow 302).

However, if the blade 122 is angularly adjusted to a second cutting plane 304 (as is conventional in compound miter saws), this cutting plane 304 will preferably intersect the working surface 114 along the same cutting line X-X, although the cutting plane will be angularly disposed relative to the working surface 114. However, since the fence member 134 is angularly adjustable on the working surface 114 relative to the cutting line X-X then its effectiveness will not be affected by angular inclination of the cutting plane 304.

FIG. 5 also illustrates the benefit of providing the fence member 134 with inclined edges 386 adjacent to the recess 136 to accommodate such an inclined cutting plane so that the fence member 134 will not interfere or engage the blade 122 as it is displaced towards the working surface 114 along this inclined cutting plane 304.

It will be appreciated that there are many variations to the specific embodiments described herein which still fall within the general scope of the current invention, where the fence of such a miter saw is angularly adjustable relative to a fixed work surface 114. In particular, the slots 173 shown in FIGS. 3 and 4 need not be parallel to the cutting line X-X and may in fact be arcuate (and, in FIG. 3, co-axial with the pivot point 163) with the associated restraint member 165 thereby secured from longitudinal displacement on the fence member 134 and simply able to follow the pre-defined arcuate path when undergoing angular displacement.

In addition, while the preferred embodiment has been described with the restraint members 165 being slideably adjustable along slots 173, an alternative embodiment to that shown in FIG. 3 may employ an engagement mechanism mounted on the fence member 134 which is only co-operable with the table at pre-determined angular positions (for example every 5°). An example of this embodiment employs the use of a spring biased projection member, biased towards engagement with the working surface 114, for co-operable engagement with an array of apertures formed therein at pre-determined angular orientations. Thus to effect a change of angle β a spring biased member is lifted out of engagement with one such hole or aperture in the working surface 114, whereby subsequent angular adjustment of the fence member 134 about the axis 163 displaces such spring biased projection until it overlay a further hole in the work surface, and released into engagement therewith. Again such holes in the working surface 114 could be arrayed along an arcuate path coaxial with the axis 163 or alternatively the spring bias projection could be slideably mounted on the fence member 134 with the array of holes being substantially linear and parallel to the cutting line X-X. Each hole would be representative of a pre-determined angular adjustment of β.

While it is preferable to rigidly interconnect to the two sections 134a, 134b of the fence member 134 by use of the support element 157, this is not essential to the operation of the invention. It is envisaged that both of the sections 134a, 134b could be independently adjustable on the working surface 114. One example of such a configuration would be for each section 134a, 134b to have, as a restraint member, an elongate downwardly extending projection for complimentary co-operation with elongate slots formed within the work surface at pre-determined orientations to the cutting line which will automatically align the two fence sections 134a, 134b at pre-determined angular orientations relative to the cutting line X-X. Alternatively, it is possible that both separate sections 134a, 134b could each employ two restraint members 165 both located in the same slots 180 and each engageable with two parallel channels 173 to provide for angular adjustment of the fence plane by alignment with pre-determined indicias marked on the working surface 114.

Still further, where the two sections 134a, 134b of the fence member 134 are not interconnected and are thus independently adjustable on the working surface 114, it would also be possible for each of these two sections to be disposed at completely different angles relative to the cutting line X-X. Here, for example, each section may be disposed at 45° to the cutting line X-X so as to form a substantial right angle between the two fence members which would allow the accurate positioning of a right angled workpiece relative to the cutting line X-X.

While the preferred embodiment herein described relates to miter saws having circular saw blades, the current invention is equally applicable to miter saws having power driven linear reciprocating blades which are displaceable towards the work surface in the previously described cutting plane.

Finally, the restraint members 165 described in the examples shown herein are by way of reference only and it is well understood and known within the art to provide many alternative forms of releasable engagement means for restraining adjustable articles to a work surface, all of which are considered to be incorporated within the current invention.

Persons skilled in the art may recognize other additions or alternatives to the means disclosed herein. However, all these additions and/or alterations are considered to be equivalents of the present invention.

What is claimed is:

1. A miter saw comprising:
a base comprising a working surface;
a saw assembly pivotably connected to the base, the saw assembly comprising a blade, the blade being movable in a first cutting plane, the cutting plane intersecting the working surface along a first cutting line; and
an adjustable elongated fence mounted on and supported by the working surface, the fence being angularly displaceable relative to the first cutting line.

2. A miter saw as claimed in claim 1, wherein the blade is adjustable so as to adjustably incline the cutting plane relative to the work surface.

3. A miter saw as claimed in claim 1, wherein the working surface is non-adjustably mounted on the base.

4. A miter saw as claimed in claim 1, wherein the working surface comprises a recessed channel along the first cutting line.

5. A miter saw as claimed in claim 1, wherein the fence comprises at least one releasable restraining member for restraining the fence to the work surface in a plurality of angularly adjusted orientations relative to the cutting line.

6. A miter saw as claimed in claim 1, wherein the fence comprises a restraining member comprising a first member disposed in the working surface and threadingly engaged to a second member disposed on the fence.

7. A miter saw as claimed in claim 1, wherein the fence is longitudinally adjustable along the cutting line.

8. A miter saw as claimed in claim 1, wherein the fence extends over the cutting line.

9. A miter saw as claimed in claim 7, wherein the fence comprises a recess for overlying the cutting line in the working surface.

10. A miter saw as claimed in claim 9, wherein the fence comprises at least two separate elongated sections, each section presenting a support face extending perpendicular to the working surface and lie in a same fence plane, with the recess formed by a break between said separate sections.

11. A miter saw as claimed in claim 10, wherein at least one end of the separate sections is inclined longitudinally outwardly of the break so as to accommodate the blade when the cutting plane is inclined relative to the working surface.

12. A miter saw as claimed in claim 9 wherein the separate sections are interconnected by a rigid support element extending between the separate sections remote from the recess.

13. A miter saw as claimed in claim 12, wherein the support element extends outside of the fence plane.

14. A miter saw as claimed in claim 1, wherein the fence is pivotally mounted on the working surface about at least one pivot axis.

15. A miter saw as claimed in claim 1, wherein the working surface comprises a first guide track and the fence comprises a first track follower member in cooperative sliding engagement therewith.

16. A miter saw as claimed in claim 15, wherein the working surface comprises a second two track and the fence comprises a second track follower member for respective cooperating engagement therewith.

17. A miter saw as claimed in claim 15, wherein the first track follower member is longitudinally adjustable along the fence.

18. A miter saw as claimed in claim 15, wherein the first track is linear.

19. A miter saw as claimed in claim 15, wherein the first track is arcuate.

20. A miter saw as claimed in claim 15 wherein the fence is pivotally mounted about the first track follower member.

21. A miter saw as claimed in claim 1 wherein the working surface comprises an array of first engagement means for cooperative releasable engagement with at least one second engagement means on the fence for restraining the fence on the working surface at a predetermined angular inclination relative to the cutting line, wherein engagement of the second engagement means with a different one of the array of first engagement means restrains the fence in a second predetermined angle relative to the cutting line.

22. A miter saw as claimed in claim 21 wherein the first engagement means comprises an array of holes in the working surface and the second engagement means comprises at least one projection member for engagement with one of the array of holes.

23. A miter saw as claimed in claim 22 wherein the projection member is longitudinally adjustable along the fence.
